(19) United States
(12) Patent Application Publication
(10) Pub. No.: US 2010/0315543 A1
(43) Pub. Date: Dec. 16, 2010

(54) METHOD FOR CONVERTING A RESOLUTION AND IMAGE SENSOR THEREOF

(75) Inventors: Hwa-Young KANG, Suwon-si (KR); Kang-Hoon Lee, Seongnam-si (KR); Young-Kwon Yoon, Seoul (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/580,817

(22) Filed: Oct. 16, 2009

(30) Foreign Application Priority Data
Jun. 12, 2009 (KR) 10-2009-0052532

(51) Int. Cl. G06K 9/32; H04N 5/222

(52) U.S. Cl. 348/333.11; 382/299; 348/E05.022

(57) ABSTRACT

A method for converting resolution of images for a preview mode from an image sensor to provide the images through a display apparatus is provided, which includes (a) providing resolution information of the display apparatus to the image sensor side, (b) providing the images having the resolution that coincides with the resolution information from the image sensor to the display apparatus side, and (c) providing the images from the image sensor to the user. A method for converting resolution of images for a preview mode from an image sensor to provide the images through a display apparatus is also provided, which includes (a) providing resolution information of the display apparatus to the image sensor side, and (b) providing the images having the resolution that coincides with the resolution information from the image sensor to the display apparatus side, wherein the step (b) alternately removes pixels constituting the images, and removes pixels in different positions among the neighboring images. In addition, an image sensor for providing images of an object to a user through a display apparatus by executing a preview mode is provided, which includes a plurality of pixels for detecting successive images from light incident from the object, a digital conversion unit for converting analog images provided from the respective pixels to digital images, and a resolution conversion unit for converting the digital images provided from the digital conversion unit into images having resolution that coincides with resolution of the display apparatus to provide the converted images to the display apparatus.

### PRIORITY

This application claims the benefit under 35 U.S.C. §119(a) of a Korean Patent Application filed in the Korean Intellectual Property Office on Jun. 12, 2009 and assigned Serial No. 10-2009-0052532, the disclosures of which are incorporated herein by reference.

### BACKGROUND OF THE INVENTION

1. Field of the Invention

The present invention relates to a method and an apparatus for previewing an image, and more particularly to a method and an apparatus for previewing an image detected by an image sensor through a display screen.

2. Description of the Related Art

In general, an image sensor is a device for converting an input light into electric data, which converts light input through an optical device such as a lens into image information in the form of electric data to provide the converted image information to a user. The image sensor has been used in diverse fields, such as a medical appliance, a security appliance, a digital camera, a cellular phone on which a digital camera is mounted, and the like. Although a high-pixel image sensor that can provide images of high picture quality and high resolution has recently been developed, a portable digital appliance, such as a digital camera or a cellular phone, is provided with a display apparatus having a pixel density lower than that of the image sensor due to its limitations in size. The display apparatus may be an image output apparatus for providing image information to a user, and may include an organic liquid crystal display and so on.

Before photographing an object, a digital camera, a cellular phone, or a camcorder provides images of the object in real time so that a user can determine a proper time for photographing the object, and a mode in which the digital appliance provides in real time a plurality of images to the user through an image sensor and a display apparatus mounted thereon so that the user can determine the time for photographing the image is called a preview mode.

Consequently, due to the resolution of the display apparatus that is lower than the resolution of the image sensor or the limitations in size of the digital appliance, it is required to convert the size of preview images or moving images (or frames) into a size that can be accommodated on the display apparatus when such images are transmitted from the image sensor to the display apparatus.

However, such conversion of the size of the images as described above, which should be performed in real time while the preview mode is provided, takes a lot of time, and thus the non-continuance of the images caused by the delay of conversion of the images provided from the image sensor may occur during the preview mode. Also, the resolution of the image provided to the user through the display is greatly lowered in comparison to the resolution of the converted image through the image sensor, and thus there is a possibility that distorted information of the object is provided to the user.

### SUMMARY OF THE INVENTION

Accordingly, the present invention has been made to solve the above-mentioned problems occurring in the prior art, and the present invention provides a method for converting the size of images provided from an image sensor to a user through a display apparatus, which can minimize lowering of a processing speed due to the conversion of the image size and deterioration of the picture quality of the images provided to the user.

In accordance with an aspect of the present invention, there is provided a method for converting resolution of images for a preview mode from an image sensor to provide the images through a display apparatus, which includes the steps of (a) providing resolution information of the display apparatus to the image sensor side; (b) providing the images having the resolution that coincides with the resolution information from the image sensor to the display apparatus side; and (c) providing the images from the image sensor to the user.

In accordance with another aspect of the present invention, there is provided a method for converting resolution of images for a preview mode from an image sensor to provide the images through a display apparatus, which includes the steps of (a) providing resolution information of the display apparatus to the image sensor side; and (b) providing the images having the resolution that coincides with the resolution information from the image sensor to the display apparatus side; wherein the step (b) alternately removes pixels constituting the images, and removes pixels in different positions among the neighboring images.

In accordance with still another aspect of the present invention, there is provided an image sensor for providing images of an object to a user through a display apparatus by executing a preview mode, which includes a plurality of pixels for detecting successive images from light incident from the object; a digital conversion unit for converting analog images provided from the respective pixels to digital images; and a resolution conversion unit for converting the digital images provided from the digital conversion unit into images having resolution that coincides with resolution of the display apparatus to provide the converted images to the display apparatus.

### BRIEF DESCRIPTION OF THE DRAWINGS

The above and other aspects, features and advantages of the present invention will be more apparent from the following detailed description taken in conjunction with the accompanying drawings, in which:

FIG. 1 is a flowchart explaining a method for converting resolution of images provided to a display apparatus during a preview mode according to a first embodiment of the present invention;

FIGS. 2A to 2C are flowcharts explaining in detail respective processes for converting resolution as illustrated in FIG. 1;

FIG. 3 is a flowchart explaining a method for converting resolution of images provided to a display apparatus during a preview mode according to a second embodiment of the present invention; and

FIGS. 4A and 4B are views explaining relations between successive images provided to the display apparatus of FIG. 3.

### DETAILED DESCRIPTION OF THE EXEMPLARY EMBODIMENT

Hereinafter, exemplary embodiments of the present invention will be described with reference to the accompanying drawings. In the following description, the same elements will be designated by the same reference numerals although they are shown in different drawings. Further, various specific definitions found in the following description, such as specific values of packet identifications, contents of displayed information, etc., are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

The present invention relates to a preview mode for providing images of an object to a user before photographing a motion picture or a still picture so that a user can confirm the object before photographing the object, and suppresses lowering of a speed of providing images in a preview mode, deterioration of a picture quality, and the resultant non-continuance of the images due to due to a difference in resolution between an image sensor and a display apparatus during a preview mode.

In explaining the present invention, an image means a frame being provided for a preview mode, and a picture means information which is provided through a display apparatus for a preview mode and which can be visually recognized by a user.

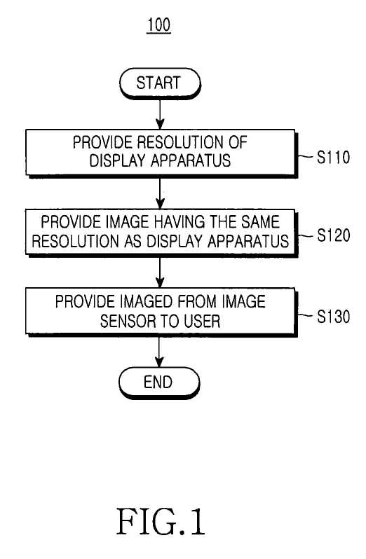

FIG. 1 is a flowchart explaining a method for converting resolution of images provided to a display apparatus during a preview mode according to a first embodiment of the present invention. Referring to FIG. 1, the method for converting resolution of images for a preview mode from an image sensor to provide the images through a display apparatus, includes the steps of (a) providing resolution information of the display apparatus to the image sensor side (step S110), (b) providing the images having the resolution that coincides with the resolution information from the image sensor to the display apparatus side (step S120), and (c) providing the images from the image sensor to the user (step S130).

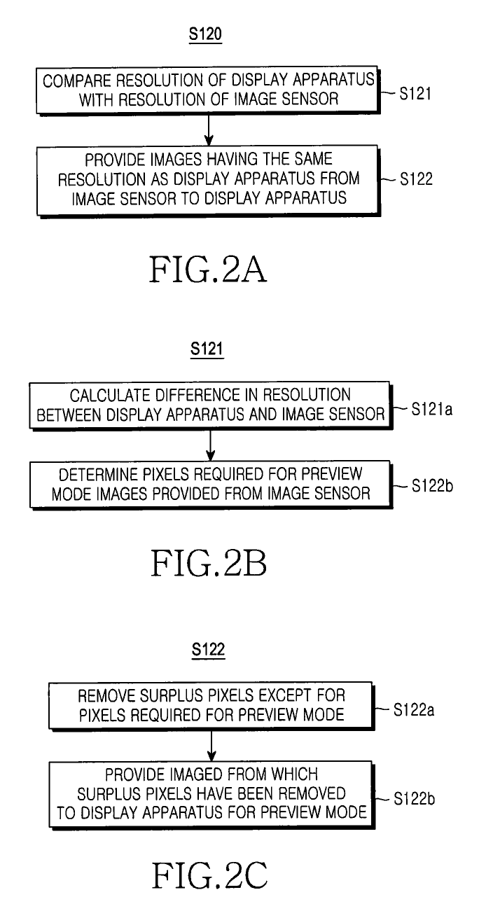

FIGS. 2A to 2C are flowcharts explaining in detail respective processes for converting resolution as illustrated in FIG. 1. Specifically, FIG. 1 is a view explaining the step (b) (i.e. step S120). Referring to FIG. 2A, the step (b) (i.e. step S120) includes the steps of comparing the resolution of the display apparatus with the resolution of the image sensor (step S121), and providing the images having the same resolution as the display apparatus for the preview mode from the image sensor to the display apparatus (step S122).

FIG. 2B is a view explaining the step of comparing the resolution of the display apparatus with the resolution of the image sensor (step S121). Referring to FIG. 2B, the step of comparing the resolution of the display apparatus with the resolution of the image sensor (step S121) includes the steps of calculating a difference between the resolution of the display apparatus and the resolution of the image sensor (step S121a), and determining the number of pixels required for the images provided by the image sensor for the preview mode in accordance with the calculated difference (step S121b).

FIG. 2C is a view explaining the step of providing the images having the same resolution as the display apparatus for the preview mode from the image sensor to the display mean (step S122). Referring to FIG. 2C, the step of providing the images having the same resolution as the display apparatus for the preview mode from the image sensor to the display mean (step S122) includes the steps of removing the surplus pixels except for the pixels required for the preview mode (step S122a), and providing the images, from which the surplus pixels have been removed, to the display apparatus for the preview mode (step S122b).

The process of removing the surplus pixels exceeding the number of pixels required for the preview mode may be performed by alternately removing the neighboring pixels among the pixels constituting the respective images for the preview mode, or removing the pixels so that the pixels are arranged at predetermined intervals. Also, in the embodiment of the present invention, the pixels are removed in a manner that the removed pixels among the images successively provided for the preview mode do not overlap one another.

Consequently, by limiting the number of pixels that constitute the respective images provided to the display apparatus for the preview mode to match the resolution of the display apparatus, a quick preview becomes possible. Also, by removing the pixels, which do not overlap the removed pixels of other successive images, from the images provided for the preview, a user cannot recognize the deterioration of the picture quality, in spite of the resolution limitations, but can recognize the images with the resolution of the image sensor.

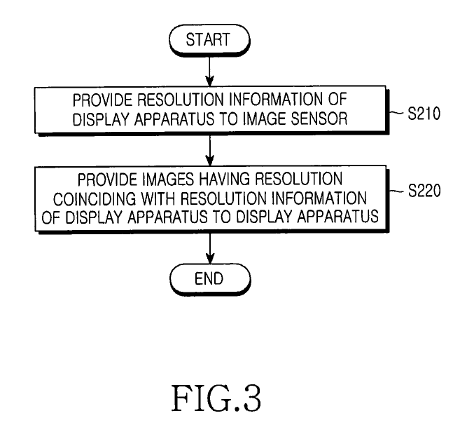

FIG. 3 is a flowchart explaining a method for converting resolution of images provided to a display apparatus during a preview mode according to a second embodiment of the present invention. Referring to FIG. 3, the method for converting resolution of images for a preview mode from an image sensor to provide the images through a display apparatus, according to the second embodiment of the present invention includes the steps of (a) providing resolution information of the display apparatus to the image sensor side (step S210), and (b) providing the images having the resolution that coincides with the resolution information from the image sensor to the display apparatus side (step S220).

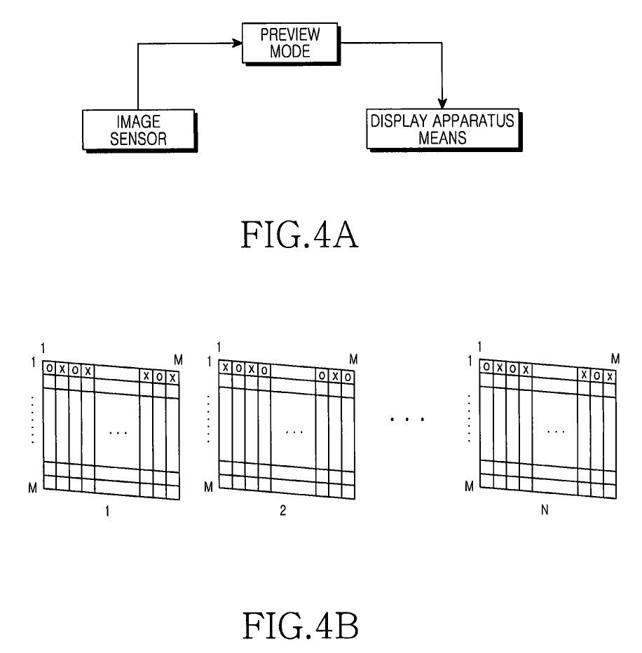

FIGS. 4A and 4B are views explaining relations between successive images provided to the display apparatus of FIG. 3. Specifically, FIG. 4A is a block diagram schematically explaining a preview mode in which successive images are provided from the image sensor to the display apparatus.

FIG. 4B is a view explaining the relations between the respective imaged provided in the preview mode and the neighboring images. The step (b) alternately removes the pixels constituting the respective images, and removes the pixels in different positions among the neighboring images.

As described above, according to the present invention, since the neighboring images, from which the pixels in different positions have been removed, are successively provided to the user through the display apparatus, the user views the overlapping images from which different pixels have been removed, respectively, and thus the user cannot feel the deterioration of the picture quality.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for converting resolution of images for a preview mode from an image sensor to provide the images through a display apparatus, the method comprising the steps of:
(a) providing resolution information of the display apparatus to the image sensor side;
(b) providing the images having the resolution that coincides with the resolution information from the image sensor to the display apparatus side; and
(c) providing the images from the image sensor to the user.

2. The method as claimed in claim 1, wherein the step (b) comprises the steps of:
comparing the resolution of the display apparatus with the resolution of the image sensor; and
providing the images having the same resolution as the display apparatus for the preview mode from the image sensor to the display apparatus.

3. The method as claimed in claim 1, wherein the step of comparing the resolution of the display apparatus with the resolution of the image sensor comprises the steps of:
calculating a difference between the resolution of the display apparatus and the resolution of the image sensor; and
determining the number of pixels required for the images provided by the image sensor for the preview mode in accordance with the calculated difference.

4. The method as claimed in claim 3, wherein the step of providing the images having the same resolution as the display apparatus for the preview mode from the image sensor to the display mean comprises the steps of:
removing the surplus pixels except for the pixels required for the preview mode; and
providing the images, from which the surplus pixels have been removed, to the display apparatus for the preview mode.

5. The method as claimed in claim 4, wherein the step of removing the surplus pixels exceeding the number of pixels required for the preview mode is performed by alternately removing the neighboring pixels among the pixels constituting the respective images for the preview mode, or removing the pixels so that the pixels are arranged at predetermined intervals.

6. The method as claimed in claim 5, wherein the pixels are removed in a manner that the removed pixels among the images successively provided for the preview mode do not overlap one another.

7. A method for converting resolution of images for a preview mode from an image sensor to provide the images through a display apparatus, the method comprising the steps of:
(a) providing resolution information of the display apparatus to the image sensor side; and
(b) providing the images having the resolution that coincides with the resolution information from the image sensor to the display apparatus side;
wherein the step (b) alternately removes pixels constituting the images, and removes pixels in different positions among the neighboring images.

8. The method as claimed in claim 7, wherein the neighboring images, from which the pixels in different positions have been removed, are successively provided to a user through the display apparatus.
